(19) United States
(12) Patent Application Publication
(10) Pub. No.: US 2014/0311279 A1
(43) Pub. Date: Oct. 23, 2014

(54) APPARATUS FOR ON DEMAND LIMITING THE VALUE RANGE OF A PARAMETER ADJUSTMENT DEVICE

(71) Applicants: Matyas TOTH, Budapest (HU); Balazs SZOBOSZLAY, Budapest (HU)

(72) Inventors: Matyas TOTH, Budapest (HU); Balazs SZOBOSZLAY, Budapest (HU)

(21) Appl. No.: 14/307,026

(22) Filed: Jun. 17, 2014

Related U.S. Application Data
(63) Continuation-in-part of application No. PCT/HU2012/000136, filed on Dec. 19, 2012.

(30) Foreign Application Priority Data
Dec. 20, 2011 (HU) P1100694
Jun. 19, 2012 (HU) P1200376

(51) Int. Cl. G05G 1/10; G05G 5/00

(52) U.S. Cl. CPC G05G 1/10; G05G 5/00
USPC 74/553

(57) ABSTRACT

An apparatus for on demand limiting the value range of a parameter adjustment device comprises a knob for moving a regulating element (1), means for creating engagement between the knob and the regulating element (1), a first stop (3) fixed in relation to the device, a second stop (6) to cooperate with the first stop (3), a shim (5) having said second stop (6), and movable independently in relation to the regulating element (1), a spring (4) an end of which is fixed to the first stop (3) and the other end is fixed to the shim (5), and a pressure element (7) having a surface for frictionally engaging said shim, and fixed against rotation to said regulating element, and means for releasably engaging said surface with said shim.

### TECHNICAL FIELD OF INVENTION

The object of this invention is an apparatus for on demand limiting the value range of a parameter adjustment device to be adjusted between pre-determined physical minimum and maximum values, the device comprising a knob for engaging a shaft of the parameter adjustment device, a first stop fixed in relation to the device, a second stop to cooperate with the first stop and means for creating engagement between the knob and the shaft. The device is suitable for narrowing or fixing the value range of a parameter-adjustment device, like a potentiometer.

### BACKGROUND OF THE INVENTION

It is desirable the value range of a parameter-adjustment device, e.g. a potentiometer adjusting light dimmer devices or electric sign sources for sound amplifiers, or other kinds of parameter-adjustment devices, rotary or slider potentiometers, to be narrowed by setting any value between the original minimum and maximum values of a parameter-adjustment device, as a new minimum or maximum value.

Above aim is intended to be solved by the solution disclosed in patent document GB 2 294 747. With this prior art solution the minimum value of the volume range of the light adjustment switch can be altered so that the value of light to be emitted when turning the light on should be preset on demand. This result is achieved by equipping the rotatable adjustment knob—more specifically the axis of the potentiometer adjusting the light volume—with a removable rotary knob that has an internal bumper comes into contact with the external knock point of the light adjustment switch allowing it only to be turned to a higher level of volume, resulting it to only provide access to adjust the volume of light to a higher degree.

Main disadvantage of this known solution is that the minimum brightness setting item is only suitable for changing the position of the dimmer switch by disassembly, and the change can only be performed by professionals and requires considerable time. Another shortcoming is that the parameters used in this existing structure and adjustment devices are not directly adaptable, but after a proper conversion of the positioning element (rotary axis). Therefore, in cases where a fast action is required to adjust the value range of a potentiometer, this solution fails to operate properly and is not capable of meeting the criteria of fast and easy change of the value range of a parameter-adjustment device, e.g. a potentiometer provided on a guitar.

Consequently, the object of this invention is to provide an device for on demand limiting the value range of a parameter adjustment device that is to narrow the value range of a parameter-configuration device by setting any value within the configurable range and by setting new minimum and maximum values, which can be changed promptly and without disassembling and reassembling the device, at any time. The device according to the invention is capable of narrowing or fixing the value range of a parameter adjustment device. The value range can be narrowed by setting any value between the parameter adjustment device's own minimum and maximum, by creating a forced connection between the adjusting part of the parameter adjustment device and the part moving on a circular scale between a starting and an ending point, that part returns to its starting position whenever the connection is broken, making it possible to set a new value. Moreover, this aim can be realized without any alteration of the parameter adjustment device by installing the device afterwards, in such a way that a forced connection can be achieved between the adjustment part of the parameter adjustment device and a part moving on a line determined by a starting and an ending point. In case of terminating the forced connection the part will return to the beginning level of its scale, by this making it possible to set a new minimum or maximum level.

### SUMMARY OF THE INVENTION

Above object can be achieved by an apparatus for on demand limiting the value range of a parameter adjustment device to be adjusted between predetermined physical minimum and maximum values, the apparatus comprising
a knob for moving a regulating element of the parameter adjustment device,
means for creating engagement between the knob and the regulating element,
a first stop fixed in relation to the parameter adjustment device,
a second stop to cooperate with the first stop,
a shim having said second stop formed thereon, and movable independently in relation to the regulating element,
a spring biasing the first stop against said second stop so that an end of the spring is fixed in relation to the first stop and the other end is fixed in relation to the shim, and
a pressure element having a surface for frictionally engaging said shim, and fixed against rotation to said regulating element, and
means for releasably engaging said surface with said shim,

wherein said engagement can be released by a force acting to the knob against the force of said means for releasably engaging said surface with said shim, in such a way that said knob can be rotated independently from the shim to adjust a new physical minimum or maximum value by rotating said knob to a desired position and then bringing it again into engagement with the shim.

Te parameter adjustment device is a rotary potentiometer, and a lower fixed nut (2) is fixed to the rotary potentiometer around its regulating element formed as a shaft, and said first stop is built in the nut.

Said knob comprises an internal knob part and an external knob part, and said pressure is formed as the external knob part of the knob.

Said internal knob part is fixed to the shaft and said external knob part can be moved along said internal knob part, and said means for releasably engaging said surface with said shim is a spring arranged between said two parts of the knob and biasing said two parts spaced apart axially.

Said internal knob part is fixed to the shaft and said external knob part can be moved along said internal knob part, and said means for releasably engaging said surface with said shim is a fixing element arranged between said two parts of the knob and suitable for fixing said two parts to each other in two different relative axial positions.

Said pressure element comprises a disc disposed around said shaft and having a surface for frictionally engaging said shim, and fixed against rotation to said shaft movable against said means for releasably engaging said surface with said shim.

According to a further aspect of the invention an apparatus for on demand limiting the value range of a parameter adjustment device is provided that is formed as a rotary potentiometer to be adjusted between pre-determined physical minimum and maximum values, the apparatus comprising
a knob for engaging a shaft of the parameter adjustment device,
a first stop (3) fixed in relation to the device,
a second stop (6) to cooperate with the first stop and means for creating engagement between the knob and the shaft, the device further comprising:
a lower fixed nut to be fixed to the parameter adjustment device around its shaft, and said first stop is built in the nut;
a pulling spring arranged in the nut so that an end thereof is fixed with the nut, and
a rotating shim placed onto said nut and fixing the other end of said spring, and said second stop is formed on the rotating shim, and wherein said knob is formed by an external knob part, and an internal knob part to be fixed to said shaft, and a pressing spring is arranged between said external knob part and said internal knob part and said internal knob part having means for fixing said internal knob part to the shaft against any relative movement therebetween, said internal knob part and said external knob part having means for fixing each other against rotation and allowing axial movement of said external knob part against the force of said spring, and wherein said external knob part is engaged frictionally with the shim by the effect of said pressing spring, and said engagement can be ceased by a force acting to the external knob part against the direction of force of said spring, in such a way that said external knob part can be rotated independently from the shim to adjust a new physical minimum or maximum value by rotating said external knob part to a desired position and then bringing it again into engagement with the shim ceasing the force acting against the force of said spring.

Means for fixing said internal knob part to the shaft against rotation is a grub screw arranged in a hole formed in said internal knob part.

Means for fixing said internal knob part and said external knob part to each other against rotation and allowing axial movement of said external knob part against the force of said spring is a polygon shaped on an external side of said internal knob part and a polygon shaped complementary on an internal side of the external knob part.

Said external knob part has a locking cap.

The internal knob part comprises means for fixing it in relation to the external knob part provisionally in both activated an inactivated position.

The internal knob part comprises means for fixing it in relation to the external knob part provisionally in both activated an inactivated position, and said means for fixing the internal knob part are lamina ribs formed on internal knob part, and the external knob part is provided by a rim for cooperating with said ribs.

The parameter adjustment device is a linear potentiometer and the circular scale is a linear scale, while all rotating movements are linear movements.

The adjusting part of a potentiometer can be connected to a fixed immobile part of the potentiometer, in order to fix an actual value.

### BRIEF DESCRIPTION OF DRAWINGS

The present invention will now be disclosed by way of describing exemplary embodiments, with reference to the accompanying drawings, in which:

FIG. 1 is an axonometric view of the device according to the invention,

FIG. 2 is an axonometric view of the device according to the invention from below,

FIG. 3 is a lateral cross-sectional view of the nut with a spring and shim,

FIG. 4 is an axonometric exploded view of the nut with a spring and shim,

FIG. 5 is an axonometric exploded view of the control knob,

FIG. 6 is a cross-sectional view of the control knob when activated,

FIG. 7 is an axonometric view of the device when inactivated, and

FIG. 8 is an axonometric view of the device when mounted on a potentiometer and activated.

In case of a potentiometer, a modified nut is attached to the threaded collar or other fix part of the potentiometer. The modified nut consists of a lower fixed part and an upper rotating part. The rotating part can only move on a rotating scale restricted by built-in-stops integrated into its lower fixed part and upper rotating part.

In a standstill position the stop of the rotating part is pulled to the stop of the fixed part provided by a force that can be achieved by a spring, magnetic force or flexible material, so the rotating part can only be turned one direction from its standstill. The rotating part can turn clockwise or counterclockwise depending on the direction of the returning force. The spring is attached to the fix part of the modified nut, with its other end attached to the rotating part. If the rotating part is set to be able to turn towards the maximum value of the potentiometer from its starting standstill, than a minimum level can be set, and when it can be turned towards the minimum value of the potentiometer a maximum level can be set.

When the rotating part is turned by applying a force to it, it will return to its starting standstill position when the force is not applied any more.

The forced connection can be broken at any time at a desired position of the potentiometer or can be established immediately.

A modified potentiometer control knob is attached to the rotating shaft of the potentiometer which is unable to rotate related to the shaft but can move parallel to it. The ability to move parallel to the shaft ensures the active or inactive state of the device.

In inactive state, the modified potentiometer control knob can be rotated independently of the rotating part of the modified nut, between the potentiometer's own minimum and maximum values.

In active state, a forced connection is established between the modified potentiometer control knob and the rotating part of the modified nut. From that time on, the modified potentiometer control knob and the modified nut can rotate only simultaneously. When the modified potentiometer control knob and the modified nut are connected, the actual value of the potentiometer will be the new minimum or maximum value of the potentiometer value range. Thus, when a new minimum value is set, the control component of the potentiometer can only move between its own maximum and the newly set minimum values. When a new maximum value is set, the control component of the potentiometer can be set between its own minimum and the newly set maximum values.

The value range of potentiometers is located between two designated minimum and maximum thresholds. If the activation of the apparatus takes place between these minimum 0 and maximum 10 values, than the set value will be the new minimum of the value range of the potentiometer, if the rotating part is allowed to move towards the maximum value of the potentiometer. For example by activating the device at value 5 of the potentiometer, we limit the interval of the potentiometer between values 5 and 10, after deactivating, we immediately get a chance to set a new minimum value.

In case of a linear potentiometer the operation described above can be achieved with the modification that the circular scale is modified to a linear scale while the rotating movement is to be modified to a linear movement. In case of a linear potentiometer the operation described above can be achieved with the modification that the circular scale is modified to a linear scale while the rotating movement is to be modified to a linear movement.

If we forcedly connect the adjusting part of a potentiometer to a fixed immobile part, the actual position of the potentiometer will be fixed on the actual value. Breaking the connection new value can be set on the potentiometer. When the connection is stopped, a new value can be set on the parameter-adjustment device.

If the rotating shaft of the potentiometer can also move axially as well, the active and inactive status can be achieved this way and it makes it possible to place the rotating part on a restricted scale inside the potentiometer.

The inner structure within the parameter adjustment device would be the easiest to create during the manufacture of the parameter adjustment device, within the parameter adjustment device itself with altering its internal structure.

The device of the present invention provides quick, immediate and simple method to narrow the value ranges. It is simple to install, can be implemented at a low price and posterior installation is possible as well. The device can be applied in the following fields
guitars, electric musical instruments, musical instrument amplifiers, effects,
sound systems, amplifiers, mixing consoles,
consumer electronics, Hi-Fi systems,
faucets, thermostats,
fishing reels,
any device on which parameters need to be set.

### DETAILED DESCRIPTION OF EMBODIMENTS

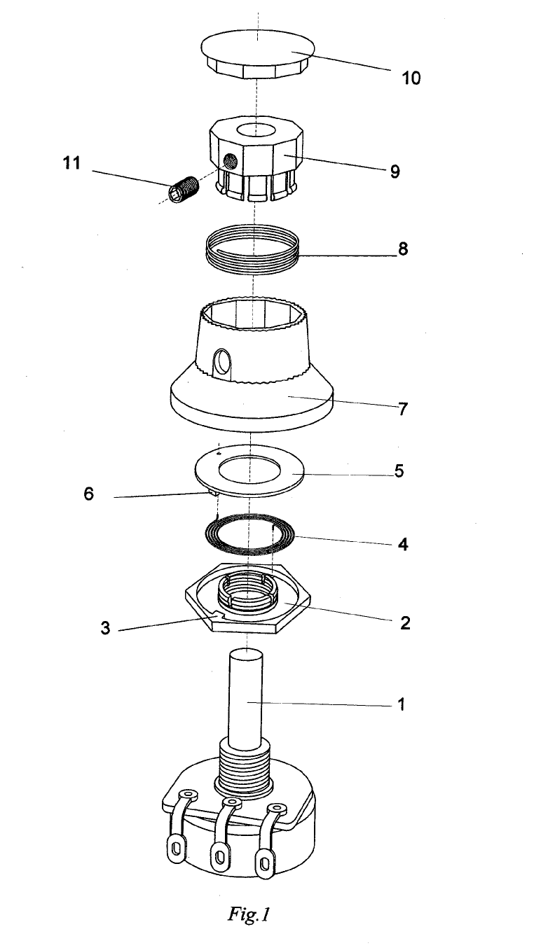

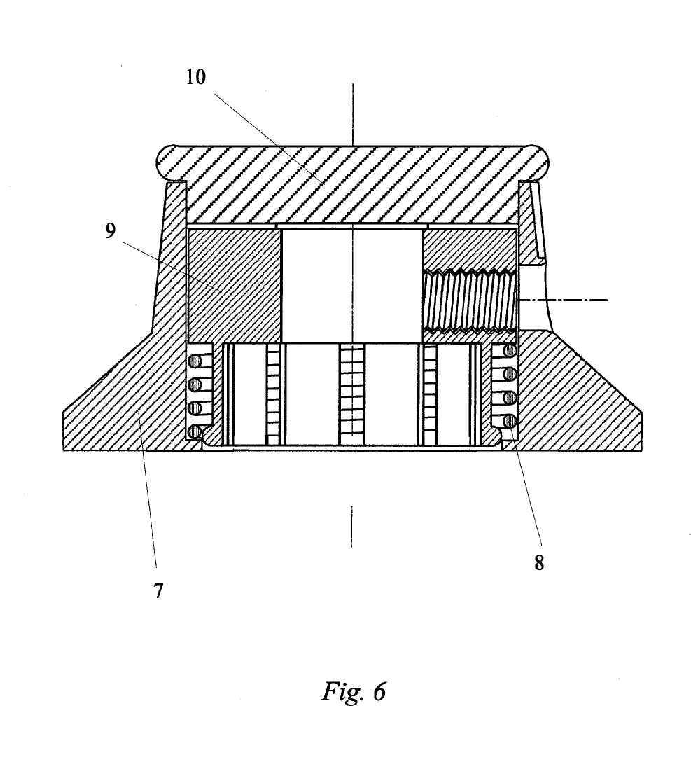

FIG. 1 is an axonometric exploded view of a preferred embodiment of the device according to the invention. The device is for on demand limiting the value range of a parameter adjustment device to be adjusted between pre-determined physical minimum and maximum values. As can be seen in the figure, a lower fixed nut 2 can be screwed onto an external thread of a shaft 1 formed on a potentiometer serving as a parameter adjustment device. A first built-in stop 3 of the lower fixed nut 2 fixed in relation to the device is formed as an obstacle to a second built-in stop 6 cooperating with the first stop 3 of a rotating shim 5 that can be placed on the top of the lower fixed nut 2. A pulling spring 4 is arranged between the lower fixed nut 2 and said rotating shim 5 in such a way that an end of the spring 4 is fixed to the lower fixed nut 2 and another end is fixed to the shim 5, which latter can be rotated against the force of the spring 4. The device according to the invention also has a knob for engaging a shaft 1 of the potentiometer or parameter adjustment device, and it comprises an external knob part 7, a pressing spring 8, an internal knob part 9, a and a grub screw 11. The internal knob part 9 is to be fixed to the shaft 1, and the pressing spring 8 is arranged between the external knob part 7 and the internal knob part 9. The internal knob part 9 is provided by means for fixing said internal knob part 9 to the shaft 1 against any relative movement therebetween. The internal knob part 9 and external knob part 7 as well have means for fixing them together against rotation but allowing axial movement of the external knob part 7 against the force of the spring 8. The external knob part 7 is engaged frictionally with the shim 5 by the effect of said pressing spring 8. That engagement can be ceased by a force acting to the external knob part 7 against the direction of force of the spring 8, in such a way that the external knob part 7 can be rotated independently from the shim 5 to set a new physical minimum or maximum value by rotating the external knob part 7 to a desired position and then bringing it again into engagement with the shim 5 by means of ceasing the force acting against the force of the spring (8). In this embodiment the means for fixing said internal knob part 9 to the shaft 1 against rotation is a grub screw 11 arranged in a hole formed in the internal knob part 9. The means for fixing said internal knob part 9 and said external knob part 7 to each other against rotation but allowing axial displacement of the external knob part 7 against the force of the spring 8 is comprises e.g. a polygon shaped on an external side of the internal knob part 9 and a complementary polygon shaped on an internal side of the external knob part 7. The external knob part 7 advantageously has a locking cap 10. The internal knob part 9 can also have means for fixing it relation to the external knob part 7 provisionally in both activated an inactivated position, by e.g. lamina ribs 9a, the ends thereof snapping in under or above a rim 7a of the external knob part 7 (FIG. 6).

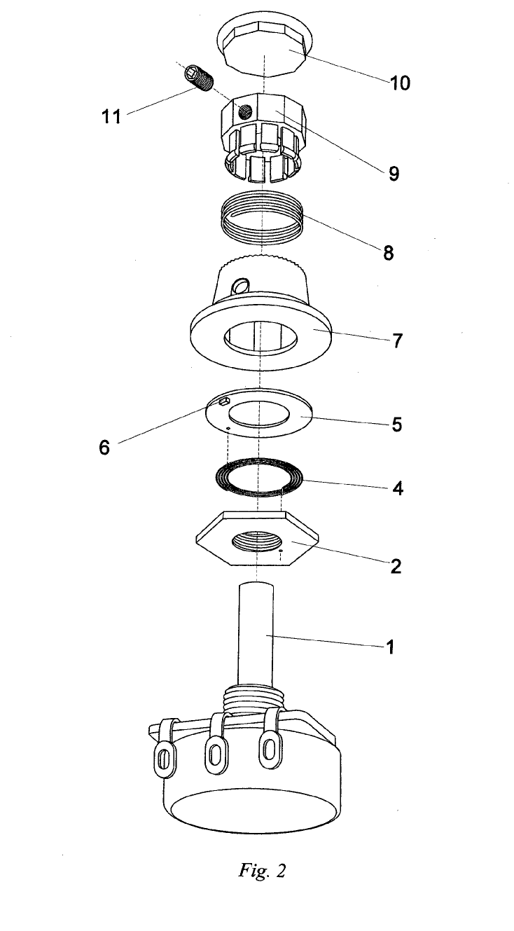

FIG. 2 is an axonometric expanded view of the device from below for better understanding.

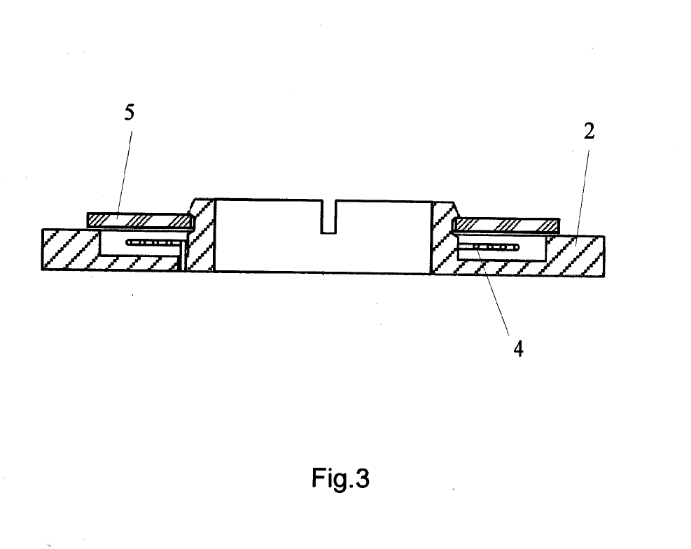

FIG. 3 is a cross-section view of the stationary lower fixed nut 2, rotating shim 5 and pulling spring 4: it provides force between the rotating shim and the lower fixed nut

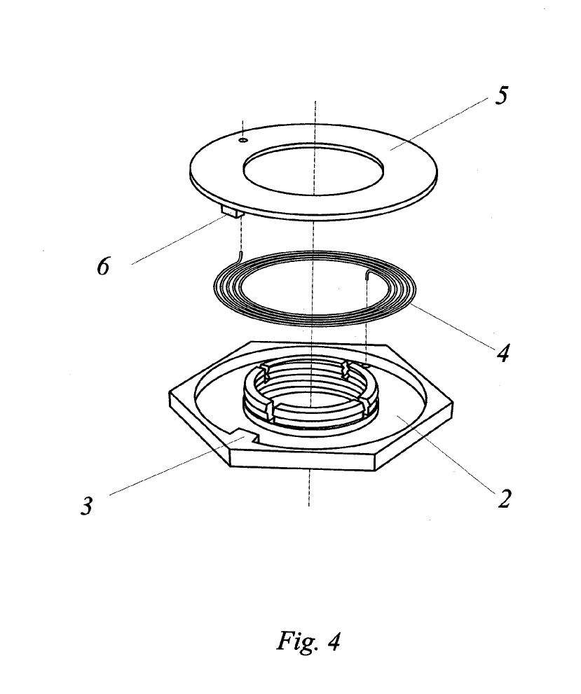

FIG. 4 is an axonometric exploded view of the lower fixed nut 2, spring 4 and shim 5. The first and second built-in stops 3 and 6 built in the lower fixed nut 2 and the rotating shim 5. One end of the pulling spring 4 is attached to the lower fixed nut 2 and the other end is attached to the rotating shim 5. In standstill position, the rotating shim 5 can rotate toward the maximum value of the potentiometer (clockwise) and the pulling spring 4 presses the built-in stop 3 of the rotating shim 5 against the built-in stop 6 of the lower fixed nut 2. This build-up of the device allows setting a new minimum value. So, the rotating shim 5 can move only to clockwise (right) along the line determined by the built-in stops 3 and 6. When the rotating shim 5 is rotated to clockwise (right) and then released, the rotating shim returns to its standstill position. A potentiometer control knob is attached to the shaft 1 of the potentiometer 1.

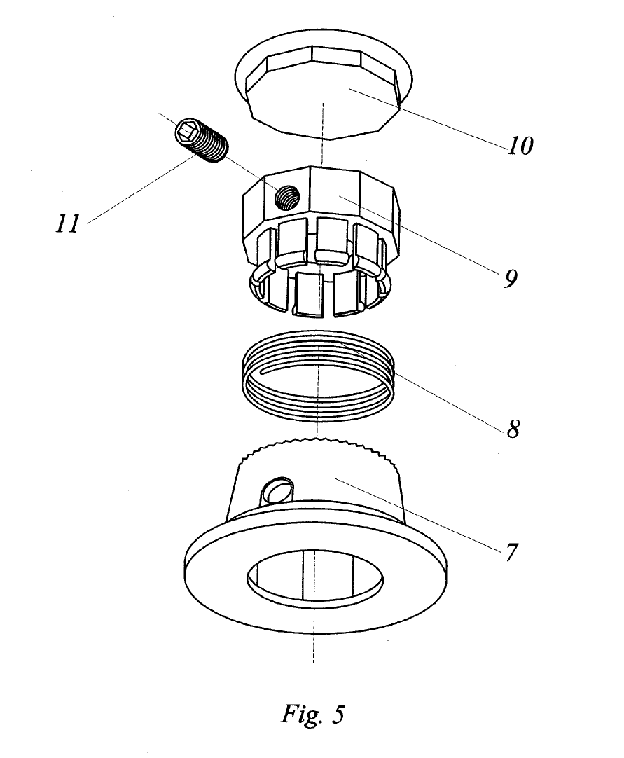

FIG. 5 is an axonometric exploded view of the control knob according to the invention. Internal knob part 9 is to be placed in an axial opening of the external knob part 7, it is protected against rotation by a form-locking connection, in this embodiment a complementary polygon shape and is provided with an axial threaded bore for the shaft 1. External knob part 7, which rotates together with the internal knob part 9 due to the form-locking connection, and can be moved axially as well and it is provided with an axial bore. Press spring 8 presses the external knob part 7 toward the shim 5 in relation to the internal knob part 9. A locking cap 10 is connected to the external knob part 7 with a form-locking connection by glue or by any other means, and its edge helps its ability to move axially. A grub-screw 11 fixes the internal knob part to the 1 potentiometer shaft.

FIG. 6 is a cross-sectional view of the control knob of the device, when activated. The pressing spring 8, then the internal knob part 9 and the locking cap 10 are placed in the external knob part 7 of the control knob. The locking cap 10 is connected to the external knob part 7 (by means of form-locking connection, glue etc.). The pressing spring 8 provides pressure between the internal and the external parts 7,9.

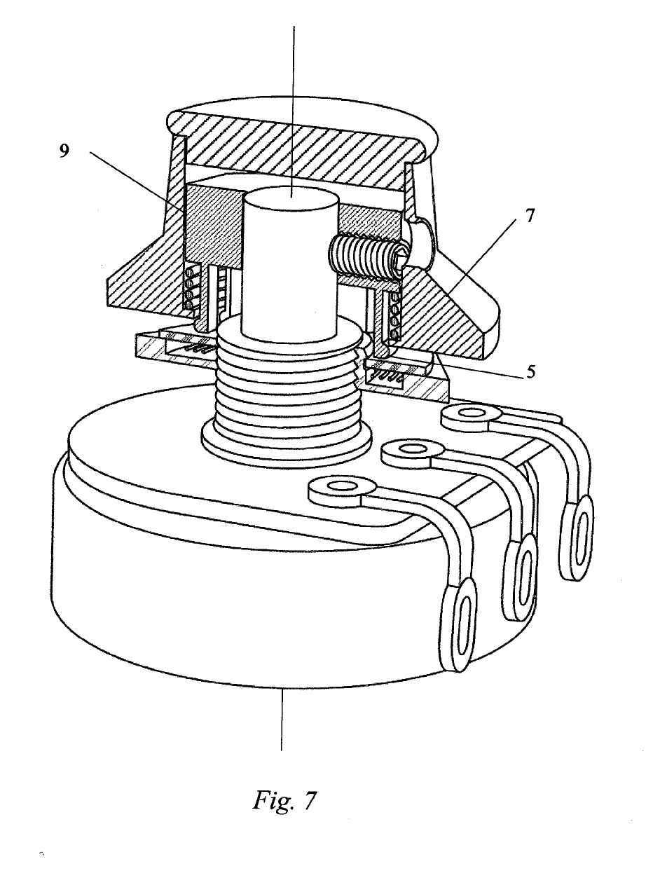

FIG. 7 is an axonometric view of the device when inactivated. In inactive (pulled up) position, there is no connection between the rotating shim 5 and the external knob part 7. The inactive position or state can be established by moving the external knob part 7 away from the rotating shim 5 axially as long as e.g. it snaps over lamina ribs 9a of the internal knob part 9 in the embodiment shown in FIG. 7. The inactive position is established when the external and the internal knob parts 7,9 are connected axially by the lamina ribs of the internal knob part 9 locking the inactive position by snapping over the external knob part 7. If no lamina ribs used, the user pulls up the external knob part 7 until e.g. the spring fully pressed and maintaining this pulling force he/she rotates the knob for a new setting position.

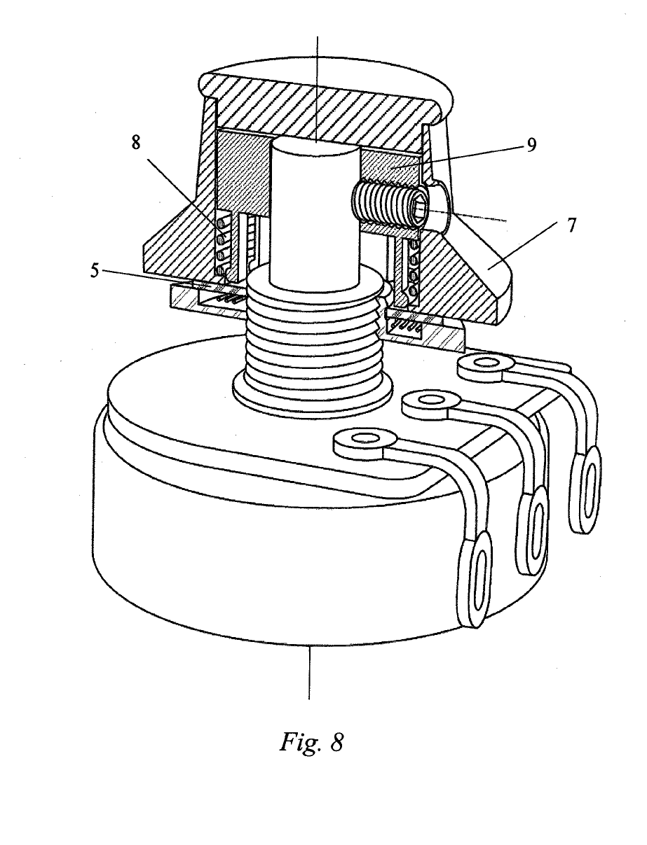

FIG. 8 is a lateral axonometric view of the device when activated. In active (pressed down) position, a forced connection is established between the rotating shim 5 and the external knob part 7. In active position, when the axial connection between the internal and external knob parts 7,9 are stopped, the spring 8 presses the external knob part 7 toward the rotating shim 5 in relation to the internal knob part 9 as long as the forced connection to the rotating shim 5 is established. After the connection is established, the rotating shim 5 and the external knob part 7 can be rotated only together. The connection is ensured by pressing force of the spring 8 and the adhesion of the surfaces of the shim 5 and part 7; the adhesion is established by strengthening the adhesion (roughening, rubberizing or painting the surfaces).

If the device is at the maximum value of the potentiometer in inactive position and the device is activated, the minimum value will be the maximum value at the same time, since the control component of the potentiometer is unable to rotate counterclockwise any more.

If the potentiometer is at the minimum value when the device is activated, no change can be seen compared to the original operation since the new minimum value is the same as the old one.

If the device is activated when the potentiometer is between the minimum and the maximum values, the newly set value will be the new minimum value of the potentiometer.

The volume control potentiometer of a guitar can set a value only between the minimum and the maximum value and has two fixed ending points.

To use the device according to the invention in a potentiometer as a parameter adjustment device, the original control knob of potentiometer has to be removed, the nut which fixes the potentiometer has to be replaced with the nut 2 of the device.

The operation of the device according to the invention takes place in general and also in special embodiments as follows:

The adjustable value range of a parameter adjustment device according to the invention can be narrowed by defining new physical minimum or maximum values, when this adjustable setting is terminated, the control component can move within the pre-determined physical values again, in order to set new physical minimum or maximum values, a forced connection must be established between the control component and a component which, owing to its structure, ensures the new physical minimum or maximum values, this component has a standstill position and it can move only in one direction because of the control component, thus, the component restricts the adjustable state of the control component, when the forced connection is terminated, the component is pushed back to its standstill position by a force, which makes it possible to establish a new physical limit, if the component is allowed to move toward the maximum value of the parameter adjustment device, a new physical minimum value can be set and if the component is allowed to move toward the minimum value, a new physical maximum value can be set at the moment the forced connection is established.

If the parameter-adjustment device is a rotary potentiometer, with a nut 2, which consists of a lower fixed part and a rotating upper part, has to be installed on the threaded collar or any other fixed part of the potentiometer, the rotating part can move only along the line determined by the stops built in the lower fixed part and the upper rotating part, in standstill position, the stop of the rotating part is pressed against the stop of the fixed part by a force, this pressing force can be provided with a spring, some elastic material, thus, the rotating part can move from its standstill position in one direction only, depending on the direction of the returning force, the rotating part can move only either clockwise or counter-clockwise, if the rotating part moves away from its standstill position due to an external force, it will return to the standstill position as soon as the force is stopped, when a spring is used, one end of the spring is attached to the fixed part of the modified nut, while the other end is attached to the rotating part, if the rotating part can move from its starting position toward the maximum value of the potentiometer, a new physical minimum value can be set, if the rotating part can move from its starting position toward the minimum value of the potentiometer, a new physical maximum value can be set, a modified potentiometer control knob, which is unable to rotate in relation to the shaft but can move parallel to it, is attached to the rotating shaft of the potentiometer, the ability to move parallel to the shaft ensures the active or inactive position of the device, in inactive position, the modified potentiometer control knob can be rotated independently of the rotating part of the modified nut, which ensures the traditional operation of the potentiometer, in active position, a forced connection is established between the modified potentiometer control knob and the rotating part of the modified nut, this connection ensures that the modified potentiometer control knob and the rotating part of the modified nut are able to move only together in active position, since the actual value of the potentiometer at which the connection is established will be the new minimum or maximum value of the potentiometer value range, thus, when a new minimum value is set, the control component of the potentiometer can only move between its own maximum and the newly set minimum values, when a new maximum value is set, the control component of the potentiometer can be set between its own minimum and the newly set maximum values, the forced connection can be terminated or established at the required position of the potentiometer on demand any time.

In the case of an embodiment shown in the drawings a parameter-adjustment device is a rotary potentiometer, with a modified nut 2 attached to the threaded collar of a rotary potentiometer 1, the modified nut consists of a nut 2 and a rotating shim 5, the rotating shim 5 is only able to rotate—clockwise or counterclockwise, depending on the installation of the rotating shim 5—as determined by the built-in-stops 3, 6 built in the nut 2 and the rotating shim 5, the rotating shim 5 moves away from its initial ending point in the allowed direction due to a force, when the force is stopped, it returns to its initial ending point, the returning force can be provided with a spring, magnetic force or some elastic material etc., when a spring is used, one end of the spring is attached to the nut of the modified nut 2, while the other end is attached to the rotating shim 5, a modified potentiometer knob is attached to the rotating shaft of the potentiometer 1, this knob consists of an external part 7, an internal part 9, a pressing spring 8 and a locking cap 10, the pressing spring 8 creates a pressing force between the internal knob part 9 and the external knob part 7, in pulled up (switched off) position, there is no connection between the rotating shim 5 and the external knob part 7, thus, the external knob part 7 of can move independently of the rotating shim 5, in switched on position, it can move connected to the rotating shim 5, when the external knob part 7 can be rotated independently of the rotating shim 5, the potentiometer can move between its own minimum and maximum values, when the external knob part 7 connected to the rotating shim (5) at any position of the potentiometer, the value set at the moment the external part 7 and the rotating shim 5 are connected will be the new minimum or maximum value of the potentiometer value range.

If the parameter-adjustment device according to the invention serves as a volume or tone control potentiometer of an electric guitar can set values between a minimum and a maximum value, the potentiometer has two fixed ending points, in order to use the object of the invention, the potentiometer control knob has to be removed and then the nut fixing the potentiometer is replaced with the modified nut 2, this modified nut consists of a lower fixed nut 2, a rotating shim 5 and a pulling spring 4 which provides force between the rotating shim 5 and the nut 2, there are stops 3, 6 built in the lower fixed nut 2 and the rotating shim 5, one end of the pulling spring 4 is attached to the lower fixed nut 2 and the other end is attached to the rotating shim 5, in starting position, the rotating shim 5 can rotate toward the maximum value of the potentiometer (clockwise) and the pulling spring 4 presses the stop 6 of the rotating shim against the built-in-stop 3 of the lower fixed nut 2, this build-up of the modified nut allows the setting of a new minimum value, so the rotating shim 5 can move only to the clockwise (right) along the line determined by the built-in-stops 3,6, when the rotating shim 5 is rotated to the right and then released, the rotating shim 5 returns to its starting position, a modified potentiometer control knob is attached to the shaft of the potentiometer 1, the components of the modified potentiometer control knob internal knob part 9 it is driven in the axial opening of the external knob part 7 by a form-locking connection, it is protected against rotation and is provided with an axial threaded bore, external knob part 7, which rotates together with the internal knob part 9 and can be moved axially as well and it is provided with an axial bore, pressing spring 8 it presses the external knob part 7 toward the modified nut in relation to the internal knob part 9, 10 locking cap, it is connected to the external knob part 7 with a form-locking connection, glue or assembling, its edge helps its ability to move axially, 11 grub-screw, it fixes the internal knob part 9 to the shaft of the potentiometer 1. The pressing spring 8, then the internal knob part 9 and the locking cap 10 are placed in the external knob part 7 of the modified potentiometer control knob, the locking cap 10 is connected to the external knob part form-locking connection, glue etc., the pressing spring 8 provides pressure between the internal knob part 9 and the external knob part 7), in inactive pulled up position, there is no connection between the rotating shim 5 and the external knob part 7, the inactive position can be established by moving the external knob part 7 away from the rotating shim 5 axially as long as it snaps over the lamina ribs of the internal knob part 9, the inactive position is established when the external knob part 7 and the internal knob part 9 are connected, the lamina ribs lock the inactive position by snapping over the external knob part 7, in active pressed down position, a forced connection is established between the rotating shim 5 and the external knob part 7, in active position, when the axial connection between the internal knob part 9 and external knob part 7 are stopped, the pressing spring (8) presses the external knob part (7) toward the rotating shim 5 in relation to the internal knob part 9 as long as the forced connection to the rotating shim 5 is established, after the connection is established, the rotating shim 5 and the external knob part 7 can be rotated only together, the connection is ensured by the pressing force of the pressing spring 8 and the adhesion of the surfaces, the adhesion is established by strengthening the adhesion (roughening, rubberizing or painting the surfaces), if the device is at the maximum value of the potentiometer in inactive position and the device is activated, the minimum value will be the maximum value at the same time, since the shaft 1 of the potentiometer, is unable to rotate counterclockwise any more, if the potentiometer is at the minimum value 0, when the device is activated, no change can be seen compared to the original operation since the new minimum value is the same as the old one, if the device is activated when the potentiometer is between the minimum and the maximum values, the newly set value will be the new minimum value of the potentiometer, thus, the potentiometer can be rotated only between these two values.

In a preferred embodiment the parameter-adjustment device has a modified nut 2 implemented inside the housing of the potentiometer, the ability to move the shaft 1 of the potentiometer axially like push-pull and push-push potentiometers mechanism, ensures the active and inactive positions.

Advantageously the forced connection is established between the control component of the potentiometer and a fixed, immobile component, the actual value of the potentiometer will be fixed, that is, when the connection is terminated, a new value can be set on the potentiometer.

The parameter-adjustment device is a rotary potentiometer a control knob is attached to the rotating shaft of the potentiometer 1, this control knob consists of an external knob part 7, an internal knob part 9, a pressing spring 8 and a locking cap 10, the pressing spring 8 creates a pressing force between the internal knob part 9 and the external knob part 7, in inactive (pulled up) position, there is no connection between the fixed nut and the external knob part 7 of the potentiometer knob, thus, the external part 7 can move independently of the fixed nut 2 with no rotating part, in active pressed down position, a forced connection is established between the external knob part 7 and the fixed nut 2, the value at the moment of the connection is set, the shaft 1 of the potentiometer cannot be rotated in either direction.

The parameter-adjustment device can also be established as a slider potentiometer.

The main advantage of the device for on demand limiting the value range of a parameter adjustment device according to the invention to narrow the value range of a parameter-configuration device by setting any value within the configurable range and by setting new minimum and maximum values, that the value can be changed promptly and without disassembling and reassembling the device.

1. Apparatus for on demand limiting the value range of a parameter adjustment device to be adjusted between predetermined physical minimum and maximum values, the apparatus comprising
a knob for moving a regulating element (1) of the parameter adjustment device,
means for creating engagement between the knob and the regulating element (1),
a first stop (3) fixed in relation to the parameter adjustment device,
a second stop (6) to cooperate with the first stop (3),
a shim (5) having said second stop (6) formed thereon, and movable independently in relation to the regulating element (1)
a spring (4) biasing the first stop (3) against said second stop (6) so that an end of the spring is fixed in relation to the first stop (3) and the other end is fixed in relation to the shim (5), and
a pressure element (7) having a surface for frictionally engaging said shim, and fixed against rotation to said regulating element, and
means for releasably engaging said surface with said shim,
wherein said engagement can be released by a force acting to the knob against the force of said means for releasably engaging said surface with said shim, in such a way that said knob can be rotated independently from the shim to adjust a new physical minimum or maximum value by rotating said knob to a desired position and then bringing it again into engagement with the shim.

2. The apparatus according to claim 1, wherein the parameter adjustment device is a rotary potentiometer, and a lower fixed nut (2) is fixed to the rotary potentiometer around its regulating element (1) formed as a shaft, and said first stop (3) is built in the nut (2).

3. The apparatus according to claim 1, wherein said knob comprises an internal knob part and an external knob part, and said pressure element (7) is formed as the external knob part of the knob.

4. The apparatus according to claim 1, wherein said internal knob part is fixed to the shaft and said external knob part can be moved along said internal knob part, and said means for releasably engaging said surface with said shim is a spring arranged between said two parts of the knob and biasing said two parts spaced apart axially.

5. The apparatus according to claim 1, wherein said internal knob part is fixed to the shaft and said external knob part can be moved along said internal knob part, and said means for releasably engaging said surface with said shim is a fixing element arranged between said two parts of the knob and suitable for fixing said two parts to each other in two different relative axial positions.

6. The apparatus according to claim 1, wherein said pressure element (7) comprises a disc disposed around said shaft and having a surface for frictionally engaging said shim, and fixed against rotation to said shaft movable against said means for releasably engaging said surface with said shim.

7. Apparatus for on demand limiting the value range of a parameter adjustment device formed as a rotary potentiometer to be adjusted between pre-determined physical minimum and maximum values, the apparatus comprising
a knob for engaging a shaft of the parameter adjustment device,
a first stop (3) fixed in relation to the device,
a second stop (6) to cooperate with the first stop (3) and means for creating engagement between the knob and the shaft, the device further comprising:
a lower fixed nut (2) to be fixed to the parameter adjustment device around its shaft, and said first stop is built in the nut;
a pulling spring arranged in the nut so that an end thereof is fixed with the nut, and
a rotating shim placed onto said nut and fixing the other end of said spring, and said second stop is formed on the rotating shim, and
wherein said knob is formed by an external knob part, and an internal knob part to be fixed to said shaft, and a pressing spring is arranged between said external knob part and said internal knob part and said internal knob part having means for fixing said internal knob part to the shaft against any relative movement therebetween, said internal knob part and said external knob part having means for fixing each other against rotation and allowing axial movement of said external knob part against the force of said spring, and
wherein said external knob part is engaged frictionally with the shim by the effect of said pressing spring, and said engagement can be ceased by a force acting to the external knob part against the direction of force of said spring, in such a way that said external knob part can be rotated independently from the shim to adjust a new physical minimum or maximum value by rotating said external knob part to a desired position and then bringing it again into engagement with the shim ceasing the force acting against the force of said spring.

8. The apparatus according to claim 7, wherein means for fixing said internal knob part to the shaft against rotation is a grub screw arranged in a hole formed in said internal knob part.

9. The apparatus according to claim 7, wherein means for fixing said internal knob part and said external knob part to each other against rotation and allowing axial movement of said external knob part against the force of said spring is a polygon shaped on an external side of said internal knob part and a polygon shaped complementary on an internal side of the external knob part.

10. The apparatus according to claim 7, wherein said external knob part has a locking cap (10).

11. The apparatus according to claim 7, wherein the internal knob part comprises means for fixing it in relation to the external knob part provisionally in both activated an inactivated position.

12. The apparatus according to claim 7, wherein the internal knob part comprises means for fixing it in relation to the external knob part provisionally in both activated an inactivated position, and said means for fixing the internal knob part are lamina ribs (9a) formed on internal knob part, and the external knob part is provided by a rim (7a) for cooperating with said ribs.

13. The apparatus according to claim 7, wherein the parameter adjustment device is a linear potentiometer and the circular scale is a linear scale, while all rotating movements are linear movements.

14. The apparatus according to claim 7, wherein the adjusting part of a potentiometer can be connected to a fixed immobile part of the potentiometer, in order to fix an actual value.
